(19) United States
(12) Patent Application Publication
(10) Pub. No.: US 2025/0252073 A1
(43) Pub. Date: Aug. 7, 2025

(54) METHODS AND APPARATUS TO IMPLEMENT A HIGH BANDWIDTH MEMORY (HBM) DIE

(71) Applicant: INTEL CORPORATION, SANTA CLARA, CA (US)

(72) Inventors: Andrew Paul Collins, Chandler, AZ (US); Sujit Sharan, Chandler, AZ (US)

(73) Assignee: INTEL CORPORATION, SANTA CLARA, CA (US)

(21) Appl. No.: 19/094,436

(22) Filed: Mar. 28, 2025

(51) Int. Cl. G06F 13/42

(52) U.S. Cl. CPC G06F 13/4221; G06F 2213/16

(57) ABSTRACT

Systems, apparatus, articles of manufacture, and methods to implement a High Bandwidth Memory (HBM) are disclosed. An example method includes identifying, with memory controller circuitry, a first input output (IO) port on the memory controller circuitry that is coupled to programmable circuitry, identifying, with the memory controller circuitry, a second IO port on the memory controller circuitry that is disconnected from the programmable circuitry, identifying a third IO port on the memory controller circuitry that is coupled to the programmable circuitry, and using, with the memory controller circuitry, one or more of the first and third IO ports to communicate with the programmable circuitry.

### FIELD OF THE DISCLOSURE

This disclosure relates generally to integrated circuit (IC) design and, more particularly, to methods and apparatus to implement a high bandwidth memory (HBM) die.

### BACKGROUND

Memory modules often couple to a circuit board (e.g., a motherboard) using different interfaces based on the amount, type, and position of the memory modules. For example, HBM is a compute memory interface for 3D stacked synchronous dynamic random access memory (SDRAM). HBM is an industry standard adopted by Joint Electron Device Engineering Council (JEDEC). Accordingly, SDRAM modules that support HBM are fabricated with standardized die dimensions.

### BRIEF DESCRIPTION OF THE DRAWINGS

FIG. 1 is an example block diagram of a compute device.

FIG. 2A, 2B, and 2C are IC layouts that couple an HBM logic die to a compute die using example techniques described herein.

FIG. 3 is an IC layout of a 2×2 compute die complex implemented using the offset configurations of FIGS. 2B and 2C.

FIG. 4A is an IC layout that includes two known HBM logic dies coupled to a compute die.

FIG. 4B is an IC layout that includes two HBM logic dies coupled to a compute die using one or more of the example techniques of FIG. 3.

FIG. 5 is a flowchart representative of example machine readable instructions and/or example operations that may be executed, instantiated, and/or performed by programmable circuitry to initialize the HBM logic dies of FIGS. 2A-2C, 3, and 4B.

FIG. 6 is a flowchart representative of example machine readable instructions and/or example operations that may be executed, instantiated, and/or performed by example memory controller circuitry to initialize the HBM logic die of FIGS. 2A-2C, 3, and 4B.

FIG. 7 is a block diagram of an example processing platform including programmable circuitry structured to execute, instantiate, and/or perform the example machine readable instructions and/or perform the example operations of FIGS. 5 and 6 to implement the compute device 100 of FIG. 1.

FIG. 8 is a block diagram of an example implementation of the programmable circuitry of FIG. 7.

FIG. 9 is a block diagram of another example implementation of the programmable circuitry of FIG. 7.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

A 3D stack of SDRAM that uses the HBM standard is implemented on top of a HBM logic die that connects the stack of memory circuits to a compute die. As used above and herein, a die refers to an area (generally in the shape of a rectangle) on a semiconductor material upon which a circuit is fabricated. For example, a compute die may implement one core of a multicore processor. More generally, a compute die may implement a portion of any type of programmable circuitry, including but not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

As the density of memory and compute resources increases in modern computing systems, the predetermined die dimensions of the HBM (and other memory technologies) standard has led to challenges in the design and layout of supporting Integrated Circuits (ICs). For example, a common IC layout configuration is to place four compute dies adjacent to one another in a 2×2 matrix (e.g., with two rows and two columns). In such examples, a given compute die generally has a post die singulation physical die size reticle limit between approximately 31.5 to 32.8 millimeters (mm). As used above and herein, a reticle limit refers to the maximum height a die can be implemented at while fitting within a given reticle (which is a photomask used during fabrication of the integrated circuit).

The increasing density of memory resources in modern computing systems has driven demand for three HBM logic dies per compute die within the 2×2 matrix configuration. Thus, each compute die in the foregoing design connects to three separate stacks of memory modules. However, the total height of three HBM logic dies positioned adjacent to one another exceeds the reticle limit of most compute dies. If a design where neither edge of a compute die is aligned with an edge of a connected HBM logic die were duplicated into the 2×2 matrix configuration, the differences in heights would form a large gap in the middle of the compute dies. Designs with such a gap are not implemented in practice because the gap increases the die-to-die channel length (signal route length) between compute dies, limiting the maximum achievable data rate and bandwidth. Additionally, in some package architectures, the mechanics of such a gap between compute dies can increase mechanical stress due to different Coefficient of Thermal Expansion (CTE) values across the multi-chip die complex. Furthermore, the inefficient use of semiconductive material that occurs with a gap between compute dies can make such a design cost prohibitive. Thus, known IC designs cannot practically implement three HBM logic dies per compute die within a 2×2 matrix of a singular compute design.

Using known techniques to implement three HBM logic dies per compute die within a 2×2 matrix of a singular compute design may cause performance issues in addition to raising cost. For instance, a given HBM logic die couples to a compute die using interconnects that physically and electrically connect Input Output (IO) ports on the HBM logic die to the IO ports on the compute die. Such interconnects have the shortest possible length when the IO ports on the compute die are linearly aligned with the IO ports on the HBM logic dies. As used above and herein, the terms “linearly aligned” and “vertically aligned” may be used interchangeably. However, in a configuration that has three known HBM logic dies per compute die within a 2×2 matrix of a singular compute design, the IO ports of one or more HBM logic dies may be unaligned with the corresponding ports on the compute dies. This physical offset between the IO ports of the two dies increases the length of the interconnects and may additionally force the routing of the interconnects to make one or more 90 degree turns. The extra length and turns of the interconnects increases parasitic capacitance and therefore decreases performance of the compute device. For example, in Embedded Multi-Die Interconnect Bridge (EMIB) devices, interconnects that connect offset IO ports between HBM logic dies may increase the maximum channel length by approximately 15% compared to interconnects that connect linearly aligned IO ports. The increased maximum channel length can consume up to 7% of the link budget and decrease the maximum data rate capability from 9.6 Gbps (Gigabytes per second) to 8.0 Gbps. In other examples, offset interconnects change bandwidth and data rate differently and/or decrease different metrics that measure performance.

Other IC designs achieve three HBM logic dies per compute die within a 2×2 matrix by using two or more different compute die designs. For instance, using two compute die designs that are a mirrored version of one another allows for the Input Output (IO) ports in the compute dies to be offset towards the outer most corners of the die complex and to vertically align with the corresponding IO ports on the HBM logic dies. Such offset enables a design that stays within the compute die reticle limit whole also aligning at least one edge of the compute die with an edge of a connected HBM logic die, thereby supporting three HBM logic dies per compute die within a 2×2 matrix. However, designing and fabricating two variants of a compute die that electrically correspond to the same circuits incurs significant costs (e.g., on the scale of tens of millions of dollars) that also makes such an approach impractical.

Example methods, apparatus, and systems described herein provide a cost effective and high performance technique to implement three HBM logic dies per compute die within a 2×2 matrix of a singular compute design. To do so, the example HBM logic dies described herein are implemented with more IO ports than the corresponding portion of the compute die (or more IO ports than are needed for operation of an HBM logic die). By changing which IO ports on the example HBM logic die are coupled to the compute die, the position of the three HBM logic dies can change relative to the position of the singular compute die design while keeping each of the interconnects linear and at their shortest distance. Example controller circuitry on the HBM logic die determines which of the interconnects are connected to the compute die and which ones are disconnected by reading from a predetermined cache or by transmitting test messages on the IO ports to identify IO ports that are coupled (as opposed to IO ports that are not coupled). Examples described herein can therefore be used to implement three HBM logic dies per compute die within a 2×2 matrix of a singular compute design while avoiding both lengthy interconnects and large gaps in between the compute dies. The examples described herein can also be used to implement an example compute die that connects to two HBM logic dies and is shorter than example compute dies that connect to known HBM logic dies, thereby reducing implementation on the integrated circuit (IC).

While examples are discussed in reference to HBM logic dies, the IO port designs and operation may be utilized with other types of memory, storage, interfaces, circuitry, etc. For example, the IO port designs may be utilized with other types of SDRAM such as dual in-line memory modules (DIMMs).

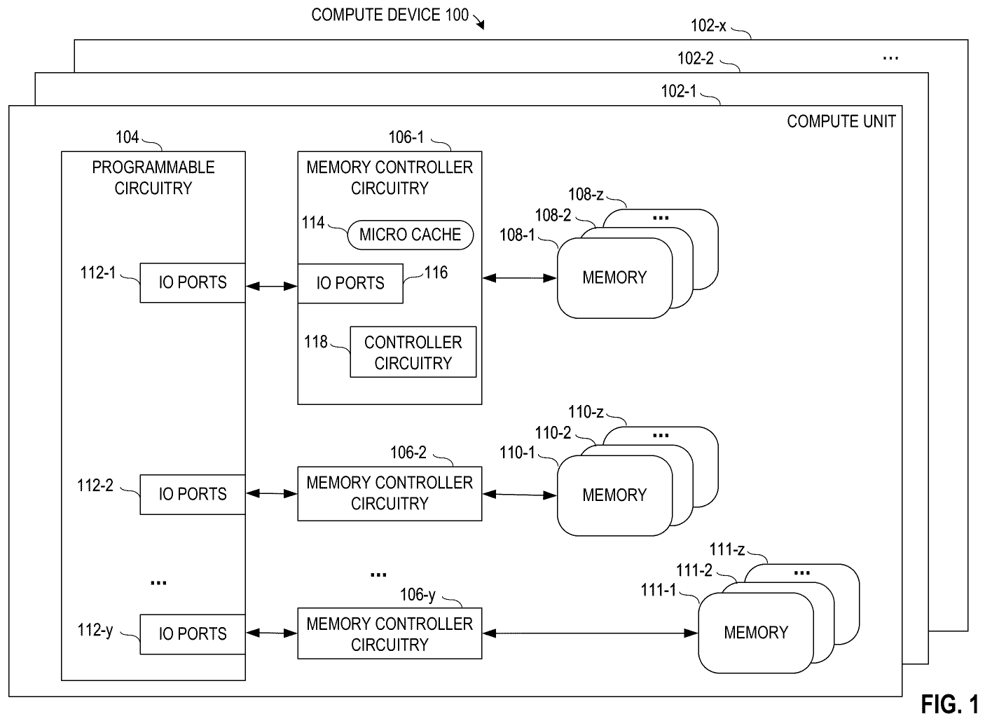

FIG. 1 is a block diagram of an example compute device 100. In the example of FIG. 1, the compute device 100 includes compute units 102-1, 102-2, . . . , 102-x (collectively referred to as compute units 102). A given compute unit 102-1 includes programmable circuitry 104, memory controller circuitry 106-1, 106-2, . . . , 106-y (collectively referred to as memory controller circuits 106), memory circuitry 108-1, 108-2, . . . , 108-z, (collectively referred to as memory circuits 108), memory circuitry 110-1, 110-2, . . . , 110-z, (collectively referred to as memory circuits 110), and memory circuitry 111-1, 111-2, . . . , 111-z, (collectively referred to as memory circuits 111). A given instance of programmable circuitry 104 includes groups of Input Output (IO) ports 112-1, 112-2, . . . , 112-y (collectively referred to as IO ports 112). A given instance of the memory controller circuitry 106-1 includes a micro cache 114, IO ports 116, and example controller circuitry 118.

The compute units 102 refer to various groupings of computational resources within the compute device 100. In some examples, a given compute unit 102-1 is referred to as a processor core.

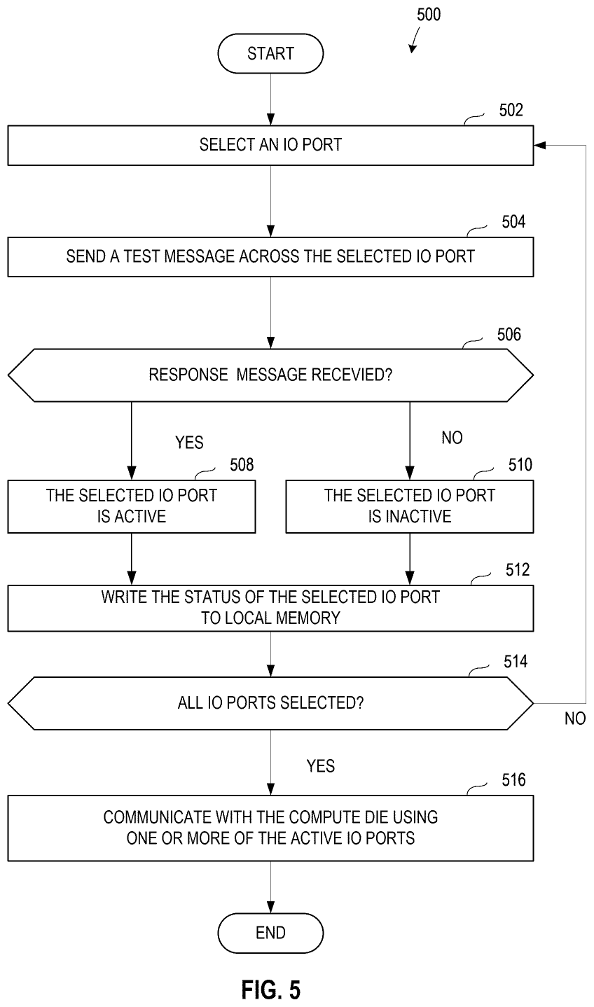

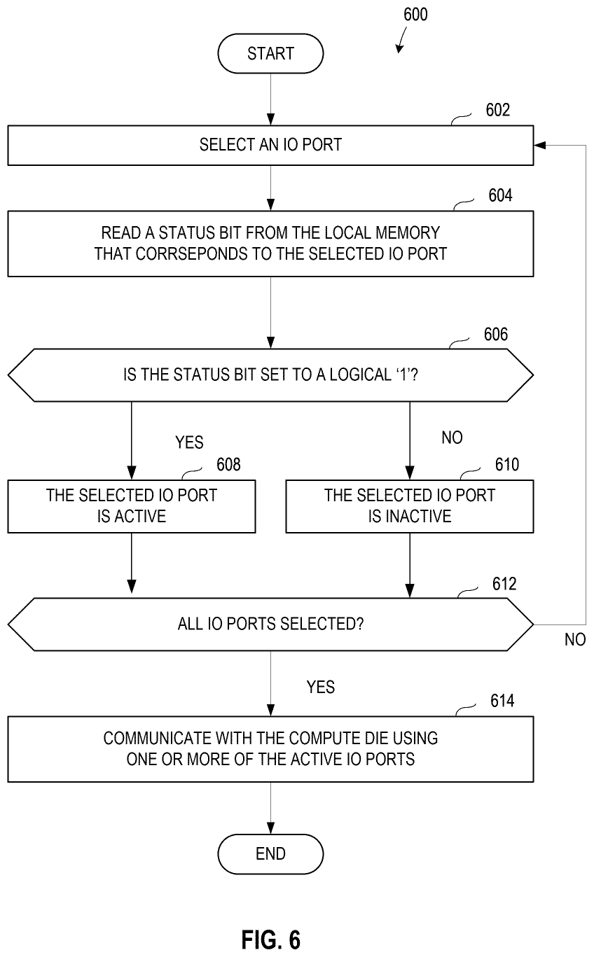

Within the compute unit 102-1, the programmable circuitry 104 can implement any type of workload by executing machine-readable instructions and/or performing operations. The programmable circuitry 104 may be implemented by any type of programmable circuitry, including but not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). In some examples, the programmable circuitry 104 executes controller instructions and/or is configured to perform operations such as those represented by the flowchart(s) of FIGS. 5 and 6.

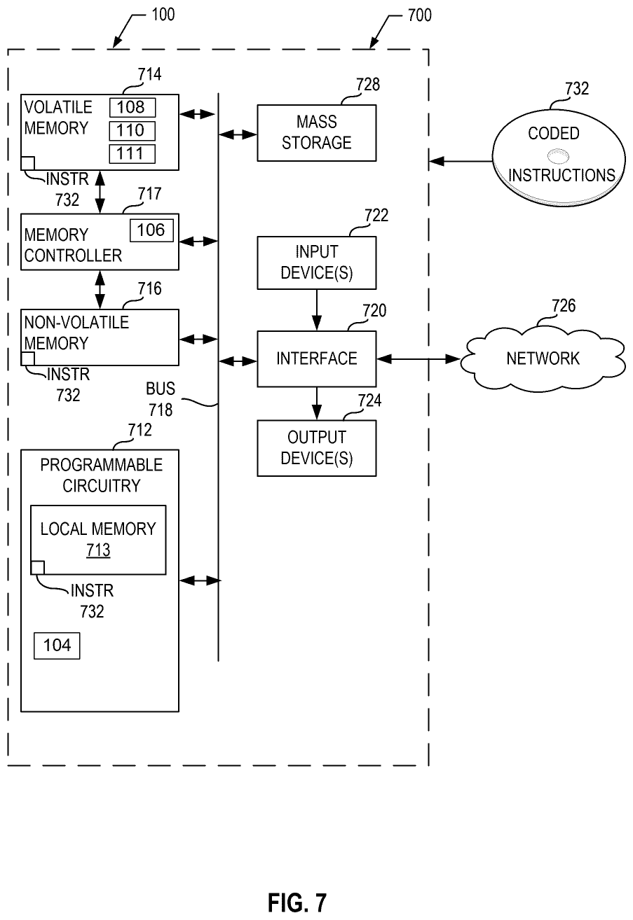

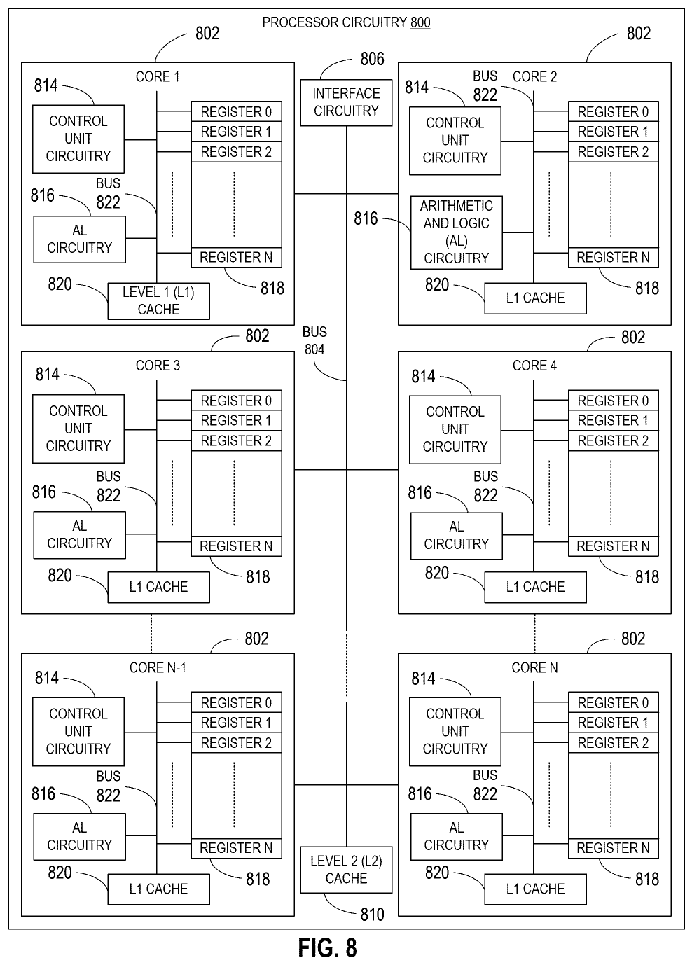

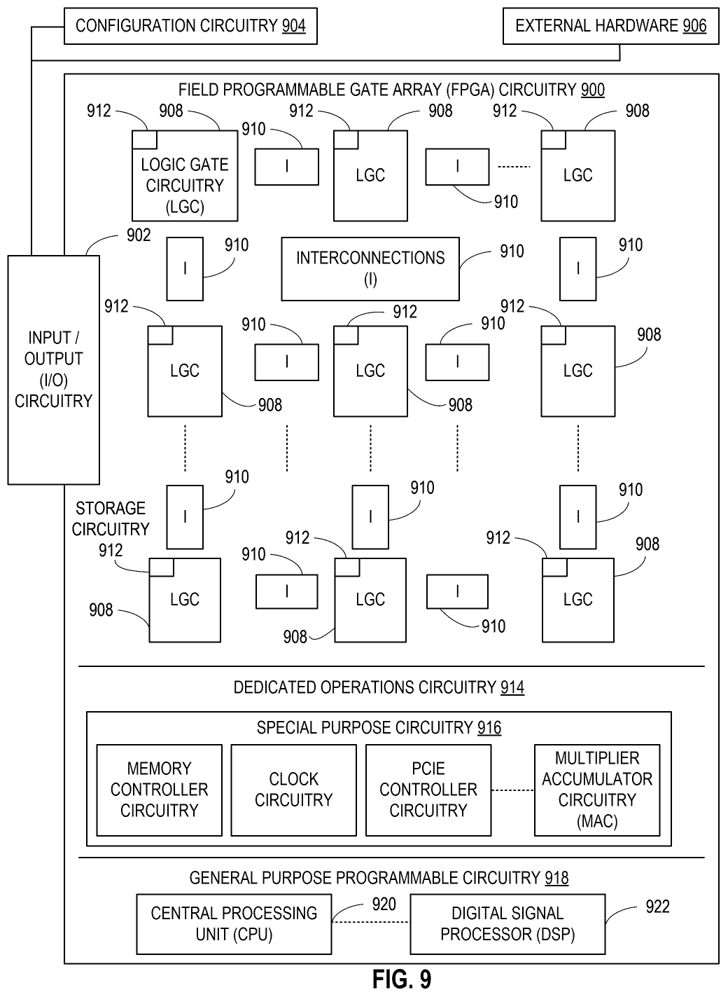

In some examples, the compute device 100 includes means for implementing a workload. For example, the means for implementing may be implemented by programmable circuitry 104. In some examples, the programmable circuitry 104 may be instantiated by programmable circuitry such as the example programmable circuitry 712 of FIG. 7. For instance, the programmable circuitry 104 may be instantiated by the example microprocessor 800 of FIG. 8 executing machine executable instructions such as those implemented by at least blocks 504, 506, 516, 614, of FIGS. 5 and 6. In some examples, the programmable circuitry 104 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the programmable circuitry 104 may be instantiated by any other combination of hardware, software, and/or firmware. For example, the programmable circuitry 104 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The programmable circuitry 104 may temporarily store data within some or all the memory circuits 108, 110, and 111 while implementing a given workload. Thus, the speed at which the programmable circuitry 104 can implement a workload is dependent on the speed at which the programmable circuitry 104 can access the data within the memory circuits 108, 110, and 111. To increase this access speed, the programmable circuitry 104 includes y groups of IO ports 112 and uses a given group of IO ports 112-1 to communicate with z of the total memory circuits in the compute unit 102-1. The programmable circuitry 104 can therefore perform a first group of read and/or write operations with the memory circuits 108 and perform a second group of read and/or write operations with the memory circuits 110 in parallel and independently of one another.

In this example, the memory circuits 108, 110, and 111 are synchronous dynamic random access memory (SDRAM). In other examples, one or more of the memory circuits 108, 110, or 111 are implemented using different type of memory. In some examples, the memory circuits 108, 110, and 111 are referred to as caches of the programmable circuitry 104.

In some examples, the compute device 100 includes means for storing data. For example, the means for determining may be implemented by the memory circuits 108 and 110.

The memory controller circuits 106 controls various caches of the programmable circuitry 104. For example, the memory controller circuitry 106-1 controls the memory circuits 108, the memory controller circuitry 106-2 controls the memory circuits 110, . . . , and the memory controller circuitry 106-y controls the memory circuits 111. Thus, in this example, each instance of the memory controller circuitry 106 controls z memory circuits. In other examples, some instances of the memory controller circuitry 106 control a different number of memory circuits than other instances of the memory controller circuitry.

Within a given instance of the memory controller circuitry 106-1, the micro cache 114 is an amount of local memory that supports the foregoing control operations. In this example, the memory within the memory controller circuits 106 are referred to as micro caches because they generally store less data than the caches (e.g., the memory circuits 108, 110, and 111) that support the operations of the programmable circuitry 104.

Within the memory controller circuitry 106-1, some of the IO ports 116 couple to a corresponding group of IO ports 112-1 on the programmable circuitry 104. In this example, the programmable circuitry 104 has y groups of IO ports 112, there are y total memory controller circuits 106 in the compute unit 102-1, and there are (y⋅z) total memory circuits in the compute unit 102-1. In other examples, there are a different number of memory controller circuits 106 and/or a different number of memory circuits in a given compute unit 102-1.

Within the memory controller circuitry 106-1, the controller circuitry 118 controls the memory circuits 108 by performing various operations. Such operations may include but are not limited to configuring and enabling the memory circuits 108 during power up, managing the flow of data to and from the memory circuits 108 and the programmable circuitry 104, ensuring data integrity and error correction of the foregoing flow of data, managing the power consumption of the memory circuits 108, etc. The controller circuitry 118 also determines which of the IO ports 116 are coupled to the IO ports 112-1 and which ones are uncoupled as described further in FIGS. 5 and 6.

The controller circuitry 118 may be implemented by any type of programmable circuitry. In some examples, the controller circuitry 118 is instantiated by programmable circuitry executing controller instructions and/or configured to perform operations such as those represented by the flowchart(s) of FIGS. 5 and 6.

In some examples, the compute device 100 includes means for controlling memory. For example, the means for controlling means may be implemented by memory controller circuitry 106. In some examples, the memory controller circuitry 106 may be instantiated by programmable circuitry such as the example programmable circuitry 712 of FIG. 7. For instance, the memory controller circuitry 106 may be instantiated by the example microprocessor 800 of FIG. 8 executing machine executable instructions such as those implemented by at least blocks 502-516 and 602-614 of FIGS. 5 and 6. In some examples, the memory controller circuitry 106 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the memory controller circuitry 106 may be instantiated by any other combination of hardware, software, and/or firmware. For example, the memory controller circuitry 106 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

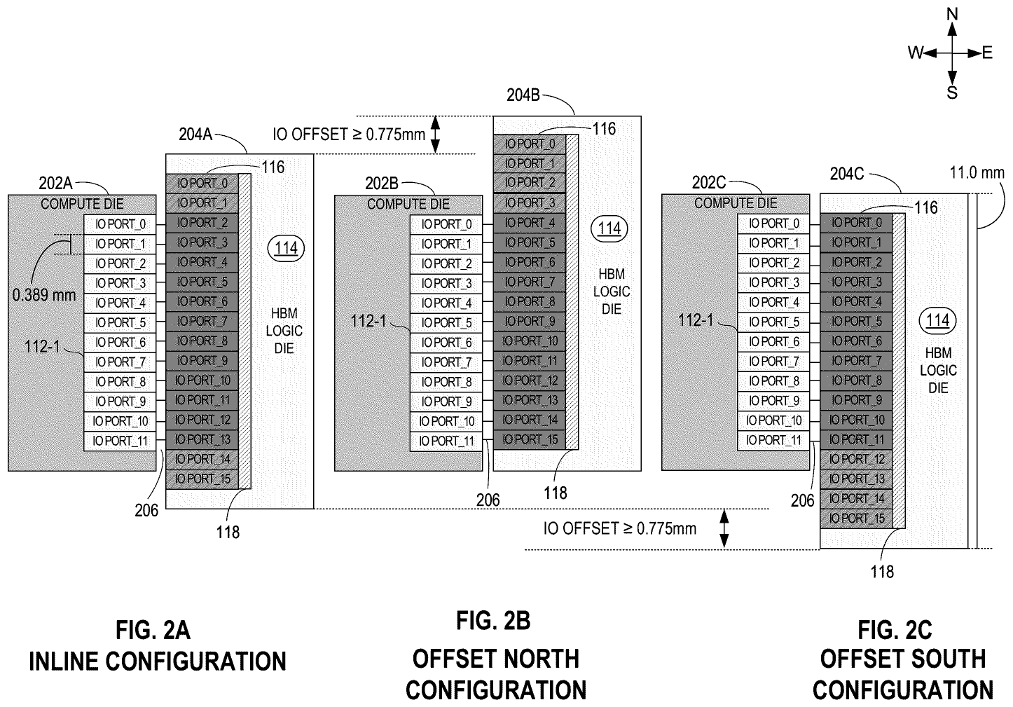

FIG. 2A, 2B, and 2C are IC layouts that couple an HBM logic die to a compute die using example techniques described herein. The examples of FIGS. 2A-2C include compute dies 202A, 202B, and 202C (collectively referred to as the compute dies 202, High Bandwidth Memory (HBM) logic dies 204A, 204B, and 204C, and interconnects 206.

As used herein, a compute die refers to a die that implements a version of the programmable circuitry 104 of FIG. 1. Similarly, as used herein, HBM logic die refers to a die that implements an instance of the memory controller circuitry 106 of FIG. 1. Thus, while the example of FIG. 1 showed the functional relationship between components in the compute unit 102-1, the examples herein that include compute dies and HBM logic dies (FIGS. 2-4) represent the approximate sizes and relative positions of the foregoing components when they are physically implemented on an integrated circuit.

In the example of FIG. 2, the compute dies 204 implement versions of the programmable circuitry 104 where y=1 as described above (meaning the programmable circuitry 104 includes only one group of IO ports 112-1). In other examples, a compute die implements versions of the programmable circuitry 104 with a different number of groups of IO ports 112.

In the examples described herein, the IO ports 112 on the compute dies 202 communicate with the IO ports 116 on the HBM logic dies 204 using a Universal Chiplet Interconnect Express (UCIe), a given IO port has a height of approximately 0.389 mm. In other examples, the IO ports 112 and 116 use a different protocol to communicate with one another and/or have a different height.

The compute dies 202A, 202B, and 202C are three copies of a single compute die design. For example, each of the compute dies 202 includes sixteen IO ports within the group 112-1. More generally, a given group of IO ports may include any number of ports, where the number of groups and the number of ports in each group is dependent on the bandwidth of the programmable circuitry 104. Furthermore, the height of the compute dies 202A, 202B, and 202C are all equal to one another, and the IO ports 112-1 are positioned equidistant between the north and south die edges in each of the compute dies 202A, 202B, and 202C.

As used above and herein, “north”, “south”, “east”, and “west” refer to different directions on a two dimensional (2D) plane. The 2D plane represents a cross-section of a three-dimensional (3D) IC that implements one or more components in the compute unit 102-1. Accordingly, each of FIGS. 2A-4 show a top-down view of one of the foregoing 2D planes. Furthermore, each sheet that includes FIGS. 2A-4 include a compass rose that aligns with the usage of the terms “north”, “south”, “east”, and “west” within this written description. In some examples, a north edge of a die is referred to as a first edge of the die and a south edge of the die is referred to as a second edge of the die. In other examples, a south edge of a die is referred to as a first edge of the die and a north edge of the die is referred to as a second edge of the die. As used above and herein, a height of a die refers to the distance between two points on the die where one point is positioned further north of the other point.

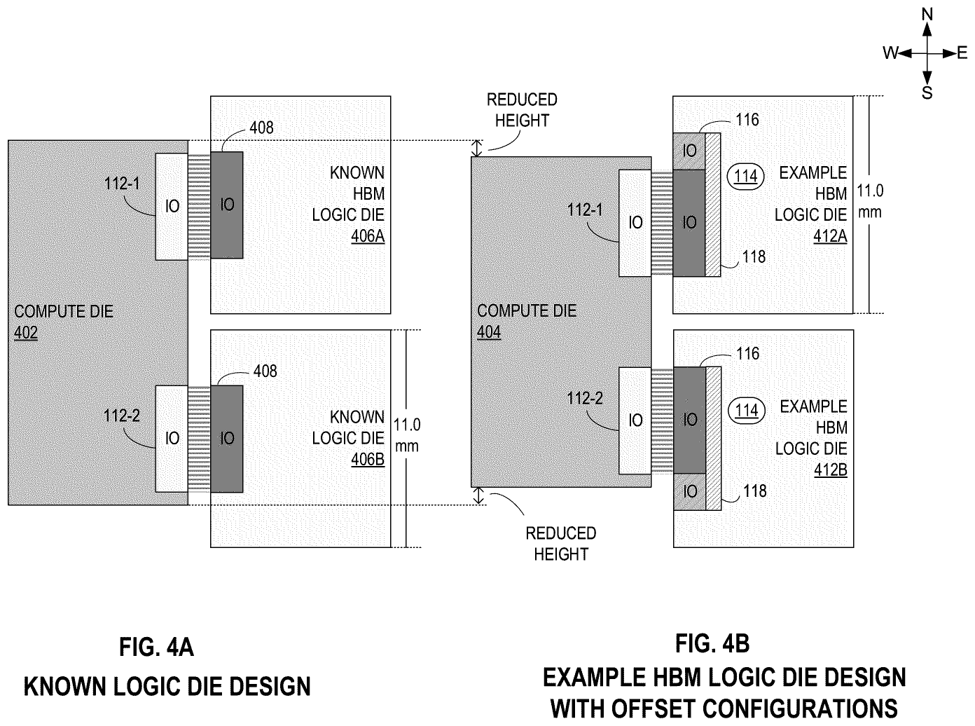

The HBM logic dies 204 each implement one instance of the memory controller circuits 106 of FIG. 1 using the standardized HBM protocol. In compliance with the protocol, the memory circuits 108, 110, and 111 are implemented as separate 3D stacks that are implemented on top of the HBM logic dies 204. Thus, the memory circuits 108, 110, and 111 are not shown in FIGS. 2A-4 because they are implemented on a different 2D plane. Like the compute dies 202, the HBM logic dies 204 are three copies of the same singular HBM logic die design. In examples described herein, a given HBM logic die has a height of approximately 11.0 mm. In other examples, an HBM logic die may have a different height as described further in connection with FIG. 4.

Advantageously, a given HBM logic die 204A implements a greater number of IO ports 116 (e.g., sixteen in FIGS. 2A-2C) than the corresponding group of IO ports 112-1 (e.g., twelve in FIGS. 2A-2C) on the corresponding compute die 202A. Thus, only a subset of the IO ports 116 on the HBM logic dies described herein are coupled to a compute die. Moreover, a manufacturer or designer of the IC that implements the compute device 100 can connect a single compute die design to a single HBM logic design in multiple different configurations to change the overall shape of the corresponding circuitry on the IC. For example, in FIG. 2A, indices 2-13 of the IO ports 116 couple to indices 0-11 of the IO ports 112-1 while indices 0, 1, 14, and 15 of the IO ports 116 are uncoupled. As a result, in FIG. 2A, the distance between the north edge of the compute die 202A and the north edge of the HBM logic die 204A is equal to the distance between the south edge of the compute die 202A and the south edge of the HBM logic die 204A. In some examples, connecting a compute die and HBM logic die so a) some uncoupled IO ports are positioned closer to an edge of the HBM logic die than the coupled IO ports and b) other uncoupled IO ports are positioned father from the edge of the HBM logic die than the coupled IO ports (as shown in FIG. 2A) is referred to as an inline configuration.

In the example of FIG. 2B, indices 4-15 of the IO ports 116 couple to indices 0-11 of the IO ports 112-1 while indices 0-3 of the IO ports 116 are uncoupled. As a result, the center of the IO ports 116 in the HBM logic die 204B is positioned north of the center of the IO ports 112-1 in the compute die 202B in FIG. 2B. Additionally, the north edge of the HBM logic die 204B in FIG. 2B and the north edge of the HBM logic die 204A in FIG. 2A are offset by approximately 0.775 mm in this example. In some examples, connecting the foregoing IO ports to one another also causes the south edge of the compute die 202B to linearly align with the south edge of the HBM logic die 204B in FIG. 2B. In some examples, connecting a compute die and HBM logic dies so that a) some inactive IO ports are positioned closer to an edge of the HBM logic die than the active IO ports and b) the HBM logic die does not include IO ports positioned farther from the edge of the HBM logic die than the active ports (as shown in FIG. 2B) is referred to an offset north configuration because the inactive IO ports on the HBM logic die are positioned to the north of those that are coupled to the compute die.

As used above and herein, IO ports on a HBM logic die that can couple to a compute die in other configurations but are not coupled to a given compute die in a given configuration may be referred to as inactive, disconnected, and/or decoupled. Similarly, as used above and herein, IO ports on an HBM logic die that are coupled to a given compute die in a given configuration may be referred to as active, connected, and/or coupled.

In the example of FIG. 2C, indices 0-11 of the IO ports 116 couple to indices 0-11 of the IO ports 112-1 while indices 12-15 of the IO ports 116 are uncoupled. As a result, the center of the IO ports 116 in the HBM logic die 204C is positioned south of the center of the IO ports 112-1 in the compute die 202C in FIG. 2C. Additionally, the south edge of the HBM logic die 204C in FIG. 2C and the south edge of the HBM logic die 204C in FIG. 2C are offset by approximately 0.775 mm in this example. In some examples, connecting the foregoing IO ports to one another also causes the north edge of the compute die 202C to linearly align with the north edge of the HBM logic die 204C. In some examples, connecting a compute die and HBM logic dies so that a) the HBM logic die includes inactive IO ports positioned further from an edge of the HBM logic die than active IO ports and b) the HBM logic die does not include inactive IO ports positioned closer to the edge of the HBM logic die than the active ports (as shown in FIG. 2C) is referred to an offset south configuration because the inactive IO ports on the HBM logic die are positioned to the south of those that are coupled to the compute die.

In the examples of FIGS. 2A-2C, twelve of the sixteen total IO ports 116 on the HBM logic dies 204 couple to the IO ports 112-1 on the compute die 202 in any given configuration. In other examples, the ratio between a group of IO ports 112-1 and the corresponding IO ports 116 is different.

Notably, the additional IO ports in the HBM logic dies 204 enable the ports that are coupled to the compute dies 202 to remain linearly aligned (e.g., in the north-south dimension) with the IO ports 112-1 in each of FIGS. 2A, 2B, and 2C. This vertical alignment enables the interconnects 206 to be implemented at their shortest possible distance and without turns, thereby maximizing performance as described above. Accordingly, the examples of FIGS. 2A-2C show the HBM logic die described herein provides flexibility in IC design (by connecting to a single compute die design in multiple different configurations) without sacrificing performance (by using minimal routing lengths to implement die-to-die interconnects) in any of said configurations.

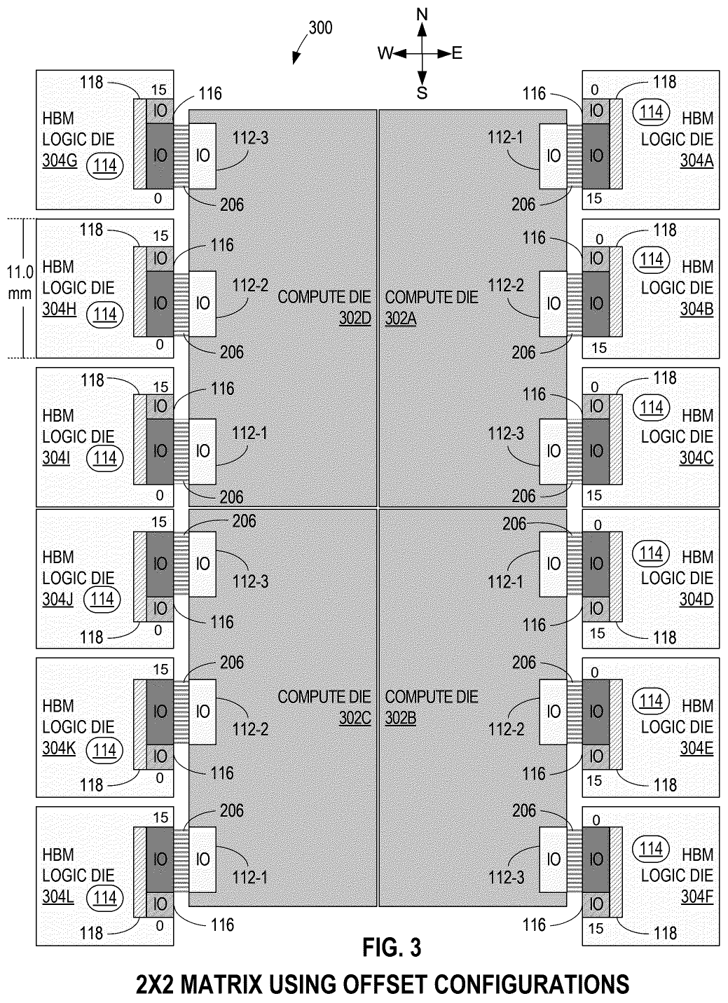

FIG. 3 is an IC layout of a 2×2 compute die complex implemented using the offset configurations of FIGS. 2B and 2C. FIG. 3 shows an example compute device 300 that includes example compute dies 302A, 302B, 302C, and 302D (collectively referred to as compute dies 302), HBM logic dies 304A, 304B, 304C, 304D, 304E, 304F, 304G, 304H, 304I, 304J, 304K, 304L (collectively referred to as HBM logic dies 304), and interconnects. In the example of FIG. 3, each of the HBM logic dies 304 include sixteen IO ports 116 and controller circuitry 118 as described above.

The compute device 300 of FIG. 3 is an example implementation of the compute device 100 of FIG. 1 where x=4 and y=3. Thus, the compute device 300 includes four compute dies 304 that each implement an instance of the programmable circuitry 104 and twelve HBM logic dies 304 that each implement an instance of the memory controller circuitry 106. Similarly, each instance of the programmable circuitry 104 includes three group of IO ports 112-1, 112-2, and 112-3 in FIG. 3. Like the compute dies 204 of FIGS. 2A-2C, the compute dies 304A-304D are four copies of one singular compute design. Similarly, the HBM logic dies 304A-304L are twelve copies of the same singular HBM logic die design shown in the examples of FIGS. 2A-2C and described herein.

FIG. 3 shows that the flexibility of the foregoing HBM logic die design enables a cost effective and high performance technique to implement three HBM logic dies per compute die within a 2×2 matrix of a singular compute design. For example, by coupling each of the HBM logic dies 304A-304C to the compute die 302A using the offset north configuration, and by coupling each of the HBM logic dies 304D-304F to the compute die using the offset south configuration, a designer or manufacturer of the compute device 300 can position the southern edge of the compute die 302A adjacent to the northern edge of the compute die with the minimal amount of distance between the two edges while keeping all of the coupled IO ports 116 on the HBM logic dies 304A and 304B linearly aligned with their respective groups of IO ports 112 on the compute dies 302A-302B. Thus, the bandwidth of the compute die 300 is maximized because the interconnects 206 are as short as possible and do not change directions (e.g., none of the interconnects 206 turn north or south) as described above. Notably, the HBM logic die design described herein allows three HBM logic dies to couple to a given compute die, and maximizes performance using the foregoing interconnects, while keeping the height of the compute die under the post die singulation physical die size reticle limit.

In contrast, consider a known compute device in which known HBM logic dies (where the number of interconnects 116 match the number of the corresponding group interconnects 112-1) are coupled to the compute dies 302A and 302B instead of the example HBM logic dies 304A-304F described herein. In such a use case, the relative position of the HBM logic dies to the compute dies would change from what is shown in the example of FIG. 3 in a manner that adds cost and decreases performance of the known compute device. For example, in the known compute die, neither the northern edge nor the southern edge of a compute die 302A can align with an adjacent known HBM logic die because doing so would exceed the post die singulation physical die size reticle limit of the compute die 302A. As a result, the distance between the southern edge of the compute die 302A and the northern edge of the compute die 302B would increase to several millimeters, forming a gap of unused semiconductor material in the middle of the known compute device (which the compute device 300 in the example of FIG. 3 avoids). As a second example, in the configuration with the known HBM logic dies, some of the IO ports on said HBM logic dies would not be linearly aligned with their corresponding group of IO ports 112 on the compute die 302A or 302B. As a result, some of the interconnects used in the known compute device would be longer than the interconnects 206 and have turns, thereby decreasing the available bandwidth due to the increased parasitic capacitance.

Advantageously, in the example of FIG. 3, components in the western half of compute device 300 (which are the compute dies 302C and 302D and the HBM logic dies 304G-304L) connect to one another using the same techniques as the eastern half of the compute device 300 (which are the compute dies 302A and 302B and the HBM logic dies 304A-304F). For example, the western half of the compute device 300 is a copy of the eastern half of the compute device 300 that has been rotated 180 degrees and translated. Namely, the compute die 302D is a rotated and translated version of the compute die 302B, the compute die 302C is a rotated and translated version of the compute die 302A, etc. Thus, the western half of the compute device 300 enjoys the same cost and performance benefits as the eastern half of the compute device 300. Furthermore, the compute device 300 implements a 2×2 configuration of compute dies using a single compute die design.

In contrast, consider a known compute device in which known HBM logic dies (where the number of IO ports 116 match the number of the corresponding group IO ports 112-1) couple to compute dies in a 2×2 matrix configuration. In such known compute devices, the change in the relative position of the HBM logic dies and the compute dies are different than the example of FIG. 3. In particular, the relative positions in such a known compute device necessitate the compute dies in the western half of the matrix to be implemented using a different compute die design than the compute dies on the eastern half of the matrix. The support and fabrication of two separate compute die designs for one compute device architecture adds significant costs to the known compute device (which the compute device 300 in the example of FIG. 3 avoids).

FIG. 4A-4B are IC layouts that both include two HBM logic dies coupled to a compute die. FIGS. 4A-4B include compute dies 402 and 404, known HBM logic dies 406A and 406B, and example HBM logic dies 412A and 412B.

The compute dies 402 and 404 are example implementations of a compute unit 102-1 in which y=2 (there are two groups of IO ports 112-1 and 112-2 per compute die). In FIG. 4A, the compute die 402 couples to the known HBM logic dies 406. The known HBM logic dies 406 correspond to known HBM logic designs where the number of IO ports 408 matches the number of IO ports in a corresponding group 112 on the compute die.

In FIG. 4B, the compute die 404 couples to the example HBM logic dies 412A and 412B using the teachings described herein. For instance, the example HBM logic die 412A implements the memory controller circuitry 106-1 using the offset north configuration of FIG. 2B and the example HBM logic die 412B implements the memory controller circuitry 106-2 using the offset south configuration of FIG. 2C.

In FIGS. 4A and 4B, both the known HBM logic dies 406 and the example HBM logic dies 412 have the same height (approximately 11 mm) as defined by the minimum die height for the HBM standard. In general, memory controller dies that implement the HBM standard must be at least as large as the SDRAM memory circuits that are stacked on top of them. The examples described herein show that the minimum HBM logic die dimensions contain enough space to implement a superset of IO ports (e.g., more IO ports than the corresponding group of IO ports on the compute die). In addition to supporting a cost effective and high performance compute device 300 of FIG. 3, the example HBM logic die design also enables compute die area savings when coupling two HBM logic dies to a compute die. This area savings, which can be seen in FIGS. 4A-4B by comparing the heights of the compute die 402 and 404, reduces cost compared to compute dies that couple to known HBM logic dies. In general, the amount of area savings is dependent on the number of inactive IO ports 116 that are added to the design of the example HBM logic dies 412.

While an example manner of implementing the memory controller circuitry 106 of FIG. 1 is illustrated in FIG. 1, one or more of the elements, processes, and/or devices illustrated in FIG. 1 may be combined, divided, re-arranged, omitted, eliminated, and/or implemented in any other way. Further, the micro cache 114, IO ports 116, the controller circuitry 118 of FIG. 1, may be implemented by hardware alone or by hardware in combination with software and/or firmware. Thus, for example, any of the micro cache 114, IO ports 116, the controller circuitry 118, and/or, more generally, the example memory controller circuitry 106, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example memory controller circuitry 106 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the memory controller circuitry 106 of FIG. 1 and/or representative of example operations which may be performed by programmable circuitry to implement and/or instantiate the compute device 100 of FIG. 1, are shown in FIGS. 5 and 6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5 and 6, many other methods of implementing the example compute device 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 5 and 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to initialize an HBM logic die described in the examples herein. While reference is made in the following description to the HBM logic die 204A and the compute die 202A, the machine-readable instructions and/or the operations 500 may be implemented by any of the HBM logic dies 204, 304, and 412.

The flowchart of FIG. 5 shows one example of how the controller circuitry 118 may determine which of the IO ports 116 are coupled to the compute die 202. In this example, the controller circuitry 118 implements the flowchart of FIG. 5 as part of a power-up/initialization process that occurs before the programmable circuitry 104 begins to communicate with the memory circuits 108, 110, or 111. The controller circuitry 118 may additionally perform other operations during such a power-up/initialization process.

The machine-readable instructions and/or the operations 500 of FIG. 5 begin when the controller circuitry 118 selects one of the IO ports 116. (Block 502). In some examples, the controller circuitry 118 selects IO ports 116 at block 502 in sequential order based on their index.

The controller circuitry 118 sends a test message across the selected IO port. (Block 504). The test message refers to an amount of data and/or a type of signal that, if received by the compute die 202A, prompts the programmable circuitry 104 on the compute die 202A to transmit a response message. In some examples, the test message of block 504 is referred to as an acknowledgement message.

The controller circuitry 118 determines whether it has received a response message from the compute die 202A. (Block 506). If the controller circuitry 118 receives a response message (Block 506: Yes), then one of the IO ports 112-1 on the compute die 202A is coupled to the selected IO port of block 502. Accordingly, in such examples, the selected IO ports is considered active. (Block 508).

Alternatively, if the controller circuitry 118 does not receive a response message (Block 506: No), the compute die 202A is not coupled to the selected IO port. In such examples, the selected IO port is inactive. (Block 510).

The controller circuitry 118 writes the status of the selected IO port to local memory. (Block 512). As used above and herein, a status of a selected IO port refers to the IO port being either active or inactive as described above. By executing block 512, the controller circuitry 118 can use the local memory to recall the status of the selected IO port after a power cycle rather than retransmitting test message. In this example, the local memory of block 512 is implemented by the micro cache 114.

The controller circuitry 118 determines whether all of the IO ports 116 have been selected. (Block 514). If all IO ports have not been selected (Block 514: No), control returns to block 502 where the controller circuitry 118 selects an IO port that had not been selected previously during the current power-up/initialization process. Alternatively, if all IO ports have been selected (Block 514: Yes), the HBM logic die 204A is prepared to communicate with the programmable circuitry 104 on the compute die 202A using one or more of the active IO ports. (Block 516). The machine-readable instructions and/or operations 500 end after block 516.

FIG. 6 is a flowchart representative of example machine readable instructions and/or example operations 600 that may be executed, instantiated, and/or performed by example memory controller circuitry to initialize the HBM logic die. While reference is made in the following description to the HBM logic die 204A and the compute die 202A, the machine-readable instructions and/or the operations 600 may be implemented by any of the HBM logic dies 204, 304, and 412.

The flowchart of FIG. 6 shows another example of how the controller circuitry 118 may determine which of the IO ports 116 are coupled to the compute die 202A. In this example, the controller circuitry 118 implements the flowchart of FIG. 5 as part of a power-up/initialization process that occurs before the programmable circuitry 104 begins to communicate with the memory circuits 108, 110, or 111. The controller circuitry 118 may additionally perform other operations during such a power-up/initialization process.

The machine-readable instructions and/or the operations 600 begin when the controller circuitry 118 selects one of the IO ports 116. (Block 602). In some examples, the controller circuitry 118 selects IO ports 116 at block 602 in sequential order based on their index.

The controller circuitry 118 reads a status bit from the local memory that corresponds to the selected IO port. (Block 604). In some examples, the status bit indicates the status of the selected IO port at block 604 because the local memory had been preprogrammed with said information during the fabrication of the HBM logic die 204A. In other examples, the status bit indicates the status of the selected IO port because the controller circuitry 118 implemented block 512 of FIG. 5 during a previous power cycle. In this example, the local memory of block 604 is implemented by the micro cache 114.

The controller circuitry 118 determines whether the status bit is set to a logical ‘1’. (Block 606). In this example, the status bit being set to a logical ‘1’ (Block 606: Yes) indicates the selected IO port is active (Block 608), and the status bit being set to a logical ‘0’ indicates the selected IO port is inactive (Block 610). In other examples, a logical ‘1’ indicates the corresponding IO port is inactive and a logical ‘0’ indicates the corresponding IO port is active. In yet other examples, the micro cache 114 of the HBM logic die 204A stores the status of the IO ports 116 using a different format.

The controller circuitry 118 determines whether all of the IO ports 115 have been selected. (Block 612). If all IO ports have not been selected (Block 612: No), control returns to block 602 where the controller circuitry 118 selects an IO port that had not been selected previously during the current power-up/initialization process. Alternatively, if all IO ports have been selected (Block 612: Yes), the HBM logic die 204A is prepared to communicate with the programmable circuitry 104 on the compute die 202A using one or more of the active IO ports. (Block 614). The machine-readable instructions and/or operations 600 end after block 614.

FIG. 7 is a block diagram of an example programmable circuitry platform 700 structured to execute and/or instantiate the example machine-readable instructions and/or the example operations of FIGS. 5 and 6 to implement the compute device 100 of FIG. 1. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements the programmable circuitry 104.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716. In this example, the memory controller 717 implements both the memory controller circuits 106 and the flowcharts of FIGS. 5 and 6.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 5 and 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 5 and 6 to effectively instantiate the circuitry of FIG. 1 as logic circuits to perform operations corresponding to those machine readable instructions. In some such examples, the circuitry of FIG. 1 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5 and 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 5 and 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5 and 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5 and 6. As such, the FPGA circuitry 900 may be configured and/or structured to effectively instantiate some or all of the operations/functions corresponding to the machine readable instructions of the flowchart(s) of FIGS. 5 and 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 5 and 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 5 and 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 5 and 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 5 and 6, and/or an ASIC may be configured and/or structured to perform third operation(s)/function(s) corresponding to a third portion of the machine readable instructions represented by the flowcharts of FIGS. 5 and 6.

It should be understood that some or all of the circuitry of FIG. 1 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 1 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “on top of” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “on top of”' is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “on top of” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “on top of” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “on top of” in the preceding paragraph (i.e., the term “on top of” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that save cost while maintaining performance of HBM logic dies. Disclosed systems, apparatus, articles of manufacture, and methods improve the efficiency of using a computing device by implementing a greater number of IO ports on the HBM logic die than the corresponding group of IO ports on the compute die, thereby enabling the position of the HBM logic die to change relative to corresponding group of IO ports on the compute die. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to implement a high bandwidth memory (HBM) die are disclosed herein. Further examples and combinations thereof include the following.
Example 1 includes a non-transitory machine readable storage medium comprising instructions to cause first programmable circuitry on memory controller circuitry to at least identify a first input output (IO) port on the memory controller circuitry that is coupled to second programmable circuitry, identify a second IO port on the memory controller circuitry that is disconnected from the second programmable circuitry, identify a third IO port on the memory controller circuitry that is coupled to the second programmable circuitry, and communicate with the second programmable circuitry using one or more of the first and third IO ports.
Example 2 includes the non-transitory machine readable storage medium of example 1, wherein the instructions cause the first programmable circuitry to identify the first, second, and third IO ports by reading a local memory on the memory controller circuitry.
Example 3 includes the non-transitory machine readable storage medium of example 2, wherein the local memory includes status bits that indicate whether a given IO port on the memory controller circuitry is coupled to the second programmable circuitry.
Example 4 includes the non-transitory machine readable storage medium of example 1, wherein the instructions cause the first programmable circuitry to send a message to the second programmable circuitry using a selected IO port on the memory controller circuitry.
Example 5 includes the non-transitory machine readable storage medium of example 4, wherein the instructions cause the first programmable circuitry to identify the selected IO port as the first IO port or the third IO port if the second programmable circuitry transmits a response to the message.
Example 6 includes the non-transitory machine readable storage medium of example 4, wherein the instructions cause the first programmable circuitry to identify the selected IO port as the second IO port if the second programmable circuitry does not respond transmit a response the message.
Example 7 includes the non-transitory machine readable storage medium of example 1, wherein the instructions cause the first programmable circuitry to write data to a local memory on the memory controller circuitry, the data to indicate whether a given IO port on the memory controller circuitry is coupled to the second programmable circuitry.
Example 8 includes the non-transitory machine readable storage medium of example 1, wherein the memory controller circuitry is implemented by a High Bandwidth Memory (HBM) logic die.
Example 9 includes a method comprising identifying, with memory controller circuitry, a first input output (IO) port on the memory controller circuitry that is coupled to programmable circuitry, identifying, with the memory controller circuitry, a second IO port on the memory controller circuitry that is disconnected from the programmable circuitry, identifying a third IO port on the memory controller circuitry that is coupled to the programmable circuitry, and using, with the memory controller circuitry, one or more of the first and third IO ports to communicate with the programmable circuitry.
Example 10 includes the method of example 9, including identifying, with the memory controller circuitry, the first, second, and third IO ports by reading a local memory on the memory controller circuitry.
Example 11 includes the method of example 10, wherein the local memory includes status bits that indicate whether a given IO port on the memory controller circuitry is coupled to the programmable circuitry.
Example 12 includes the method of example 9, including sending, with the memory controller circuitry, a message to the programmable circuitry using a selected IO port on the memory controller circuitry.
Example 13 includes the method of example 12, including identifying, with the memory controller circuitry, the selected IO port as the first IO port or the third IO port if the programmable circuitry transmits a response to the message.
Example 14 includes the method of example 12, including identifying, with the memory controller circuitry, the selected IO port as the second IO port if the programmable circuitry does not transmit a response to the message.
Example 15 includes the method of example 9, including implementing the memory controller circuitry with a High Bandwidth Memory (HBM) logic die.
Example 16 includes an integrated circuit comprising a compute die having a first number of input output (IO) ports, and a high bandwidth memory (HBM) logic die having a second number of IO ports, the second number larger than the first number, wherein a first subset of the IO ports of the HBM logic die are coupled to the IO ports of the compute die and a second subset of the IO ports of the HBM logic die are uncoupled.
Example 17 includes the integrated circuit of example 16, wherein the first subset of the IO ports of the HBM logic die couple are linearly aligned with the IO ports of the compute die.
Example 18 includes the integrated circuit of example 17, wherein the IO ports of the HBM logic die include a third number of IO ports positioned closer to an edge of the HBM logic die than the first subset, and a fourth number of IO ports positioned farther from the edge of the HBM logic die than the first subset.
Example 19 includes the integrated circuit of example 17, wherein the HBM logic die include a third number of IO ports positioned closer to an edge of the HBM logic die than the first subset, and the HBM logic die does not include IO ports positioned farther from the edge of the HBM logic die than the first subset.
Example 20 includes the integrated circuit of example 19, wherein the edge is a first edge of the HBM logic die, and an edge of the compute die is linearly aligned with a second edge of the HBM logic die.
Example 21 includes the integrated circuit of example 17, wherein the HBM logic die includes a third number of IO ports positioned further from an edge of the HBM logic die than the first subset, and the HBM logic die does not include IO ports positioned closer to the edge of the HBM logic die than the first subset.
Example 22 includes the integrated circuit of example 21, wherein an edge of the compute die is linearly aligned with the edge of the HBM logic die.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory machine readable storage medium comprising instructions to cause first programmable circuitry on memory controller circuitry to at least:
identify a first input output (IO) port on the memory controller circuitry that is coupled to second programmable circuitry;
identify a second IO port on the memory controller circuitry that is disconnected from the second programmable circuitry;
identify a third IO port on the memory controller circuitry that is coupled to the second programmable circuitry; and
communicate with the second programmable circuitry using one or more of the first and third IO ports.

2. The non-transitory machine readable storage medium of claim 1, wherein the instructions cause the first programmable circuitry to identify the first, second, and third IO ports by reading a local memory on the memory controller circuitry.

3. The non-transitory machine readable storage medium of claim 2, wherein the local memory includes status bits that indicate whether a given IO port on the memory controller circuitry is coupled to the second programmable circuitry.

4. The non-transitory machine readable storage medium of claim 1, wherein the instructions cause the first programmable circuitry to send a message to the second programmable circuitry using a selected IO port on the memory controller circuitry.

5. The non-transitory machine readable storage medium of claim 4, wherein the instructions cause the first programmable circuitry to identify the selected IO port as the first IO port or the third IO port if the second programmable circuitry transmits a response to the message.

6. The non-transitory machine readable storage medium of claim 4, wherein the instructions cause the first programmable circuitry to identify the selected IO port as the second IO port if the second programmable circuitry does not respond transmit a response the message.

7. The non-transitory machine readable storage medium of claim 1, wherein the instructions cause the first programmable circuitry to write data to a local memory on the memory controller circuitry, the data to indicate whether a given IO port on the memory controller circuitry is coupled to the second programmable circuitry.

8. The non-transitory machine readable storage medium of claim 1, wherein the memory controller circuitry is implemented by a High Bandwidth Memory (HBM) logic die.

9. A method comprising:
identifying, with memory controller circuitry, a first input output (IO) port on the memory controller circuitry that is coupled to programmable circuitry;
identifying, with the memory controller circuitry, a second IO port on the memory controller circuitry that is disconnected from the programmable circuitry;
identifying a third IO port on the memory controller circuitry that is coupled to the programmable circuitry; and
using, with the memory controller circuitry, one or more of the first and third IO ports to communicate with the programmable circuitry.

10. The method of claim 9, including:
identifying, with the memory controller circuitry, the first, second, and third IO ports by reading a local memory on the memory controller circuitry.

11. The method of claim 10, wherein the local memory includes status bits that indicate whether a given IO port on the memory controller circuitry is coupled to the programmable circuitry.

12. The method of claim 9, including sending, with the memory controller circuitry, a message to the programmable circuitry using a selected IO port on the memory controller circuitry.

13. The method of claim 12, including identifying, with the memory controller circuitry, the selected IO port as the first IO port or the third IO port if the programmable circuitry transmits a response to the message.

14. The method of claim 12, including identifying, with the memory controller circuitry, the selected IO port as the second IO port if the programmable circuitry does not transmit a response to the message.

15. The method of claim 9, including implementing the memory controller circuitry with a High Bandwidth Memory (HBM) logic die.

16. An integrated circuit comprising:
a compute die having a first number of input output (IO) ports; and
a high bandwidth memory (HBM) logic die having a second number of IO ports, the second number larger than the first number, wherein a first subset of the IO ports of the HBM logic die are coupled to the IO ports of the compute die and a second subset of the IO ports of the HBM logic die are uncoupled.

17. The integrated circuit of claim 16, wherein the first subset of the IO ports of the HBM logic die couple are linearly aligned with the IO ports of the compute die.

18. The integrated circuit of claim 17, wherein the IO ports of the HBM logic die include:
a third number of IO ports positioned closer to an edge of the HBM logic die than the first subset; and
a fourth number of IO ports positioned farther from the edge of the HBM logic die than the first subset.

19. The integrated circuit of claim 17, wherein:
the HBM logic die include a third number of IO ports positioned closer to an edge of the HBM logic die than the first subset; and
the HBM logic die does not include IO ports positioned farther from the edge of the HBM logic die than the first subset.

20. The integrated circuit of claim 17, wherein:
the HBM logic die includes a third number of IO ports positioned further from an edge of the HBM logic die than the first subset; and
the HBM logic die does not include IO ports positioned closer to the edge of the HBM logic die than the first subset.
